(19) United States
(12) Patent Application Publication
(10) Pub. No.: US 2025/0379384 A1
(43) Pub. Date: Dec. 11, 2025

(54) HIGH-PERFORMANCE BOARD-TO-BOARD CONNECTORS

(71) Applicant: Amphenol Aorora Technology (Huizhou) Co., Ltd., Huizhou (CN)

(72) Inventors: Qi Han, Huizhou (CN); Xiaohong Zhu, Huizhou (CN)

(73) Assignee: Amphenol Aorora Technology (Huizhou) Co., Ltd., Huizhou (CN)

(21) Appl. No.: 19/227,719

(22) Filed: Jun. 4, 2025

(30) Foreign Application Priority Data
Jun. 6, 2024 (CN) 202410729488.5

(51) Int. Cl. H01R 12/91; H01R 12/71; H01R 13/6581; H01R 43/26

(52) U.S. Cl. CPC H01R 12/91; H01R 12/716; H01R 13/6581; H01R 43/26

(57) ABSTRACT

High-performance board-to-board connectors. A connector system includes first and second connectors configured to mate with each other. Each connector includes signal terminals capable of satisfying PCIe Gen 4.0's signal transmission requirements at 16 Gbps, and power terminals capable of carrying a current of 13.75 A. Each connector also includes a housing with outer and inner bodies, and a shielding member disposed outside the inner body to surround the terminal mating ends. The shielding members are configured to contact each other. For the second connector, the inner body is movable relative to the outer body in a plane perpendicular to a mating direction. The terminals are configured to expand and contract in the mating direction and to move transversely relative to the mating direction along with the inner body. The shielding member comprises elastic arms that are movable relative to a board lock and configured to maintain contact with the board lock.

### CROSS-REFERENCE TO RELATED APPLICATIONS

This application claims priority to and the benefit of Chinese Patent Application No. 202410729488.5, filed on Jun. 6, 2024. The contents of this application are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors.

### SUMMARY

Aspects of the present disclosure relate to high-performance board-to-board connectors.

Some embodiments relate to an electrical connector. The electrical connector may include a housing comprising an outer housing body, and an inner housing body disposed in the outer housing body and extending beyond the outer housing body in a mating direction; a plurality of conductive elements held by the inner housing body, each of the plurality of conductive elements comprising a mating end disposed in the inner housing body, a tail end extending out of the inner housing body, and an intermediate portion between the mating end and the tail end, the plurality of conductive elements comprising a plurality of signal terminals and a plurality of power terminals disposed on opposite sides of the plurality of signal terminals; and a shielding member disposed outside the inner housing body and surrounding at least the mating ends of the plurality of conductive elements.

Optionally, the inner housing body is movable relative to the outer housing body.

Optionally, the electrical connector comprises one or more board locks, each of the one or more board locks comprising a board lock body disposed in the outer housing body, a contact portion connected to the board lock body and disposed above the outer housing body, and a space between the board lock body and the contact portion, wherein the shielding member comprises one or more elastic arms; and each of the one or more elastic arms is movably disposed in the space of a respective board lock and configured to maintain contact with the contact portion of the respective board lock when the inner housing body moves relative to the outer housing body.

Optionally, the outer housing body comprises first and second end portions disposed on opposite sides of the inner housing body; the one or more board locks are first and second board locks disposed in the first and second end portions of the outer housing body, respectively; and the one or more elastic arms are first and second elastic arms movably disposed in the spaces of the first and second board locks, respectively, and configured to maintain contact with the contact portions of the first and second board locks, respectively.

Optionally, the inner housing body comprises a chamber configured to receive a mating component; and the shielding member comprises a plurality of mating arms curving into the chamber and configured to contact with the mating component.

Optionally, the inner housing body comprises a plurality of tongues disposed in the chamber; the plurality of tongues comprise a first tongue, and second tongues disposed on opposite sides of the first tongue and spaced from the first tongue; the mating ends of the plurality of signal terminals are disposed along opposite sides of the first tongue; the mating ends of the plurality of power terminals are disposed along opposite sides of a respective second tongue; and the plurality of mating arms are disposed offset from the plurality of signal terminals.

Optionally, the intermediate portion of each of the plurality of signal terminals comprises a plurality of bending portions; and the intermediate portion of each of the plurality of power terminals comprises a plurality of segments and a plurality of gaps disposed between adjacent segments, each of the plurality of segments comprising a plurality of bending portions.

Optionally, the inner housing body and the outer housing body are integrally formed as a unitary component.

Optionally, the shielding member comprises a portion disposed between the inner housing body and the outer housing body, and contact pins extending from the portion and out of the housing.

Some embodiments relate to an electrical connector. The electrical connector may include a housing comprising an outer housing body, and an inner housing body disposed in the outer housing body and movable relative to the outer housing body; a plurality of conductive elements held by the inner housing body, each of the plurality of conductive elements comprising a mating end disposed in the inner housing body, a tail end extending out of the inner housing body, and an intermediate portion between the mating end and the tail end; a board lock comprising a board lock body disposed in the outer housing body, a contact portion connected to the board lock body, and a space between the board lock body and the contact portion; and a shielding member disposed outside the inner housing body, the shielding member comprising a shielding body, and an elastic arm extending from the shielding body into the space of the board lock body to engage the contact portion of the board lock.

Optionally, the outer housing body comprises an end portion shaped to accommodate the board lock, the end portion comprising a slot; the board lock body is disposed in the slot of the end portion of the outer housing body; and the inner housing body comprises a protrusion configured for retaining the elastic arm of the shielding member, the protrusion extending outwardly into the end portion of the outer housing body such that the elastic arm extends into the space of the board lock body.

Optionally, the protrusion comprises a first groove; the inner housing body comprises a side wall comprising a second groove connected to the first groove; and the elastic arm of the shielding member extends from the second groove into the first groove.

Optionally, the protrusion is a first protrusion; and the side wall of the inner housing body comprises second protrusions configured for retaining the shielding body of the shielding member.

Optionally, the protrusion is sized such the inner housing body is movable relative to the outer housing body in a plane perpendicular to a mating direction; and the plurality of conductive elements are configured to expand and contract in the mating direction, and to move transversely relative to the mating direction along with the inner housing body.

Optionally, the plurality of conductive elements comprise a plurality of signal terminals and a plurality of power terminals disposed on opposite sides of the plurality of signal terminals; the intermediate portion of each of the plurality of signal terminals comprises a plurality of bending portions; and the intermediate portion of each of the plurality of power terminals comprises a plurality of segments and a plurality of gaps disposed between adjacent segments, each of the plurality of segments comprising a plurality of bending portions.

Optionally, the outer housing body comprises first and second end portions disposed on opposite sides of the inner housing body; the board lock is a first board lock held by the first end portion of the outer housing body; the electrical connector comprises a second board lock held by the second end portion of the outer housing body; and the inner housing body comprises first protrusions extending into the first and second end portions of the outer housing body, respectively.

Optionally, the inner housing body comprises a chamber configured to receive a mating component, and a plurality of tongues disposed in the chamber; the plurality of tongues comprise a first tongue, and second tongues disposed on opposite sides of the first tongue and spaced from the first tongue; the mating ends of the plurality of signal terminals are disposed along opposite sides of the first tongue; and the mating ends of the plurality of power terminals are disposed along opposite sides of a respective second tongue.

Optionally, the inner housing body comprises a chamber configured to receive a mating component; and the shielding member comprises a plurality of mating arms curving into the chamber and configured to contact with the mating component.

Some embodiments relate to a method of operating an electrical connector system comprising first and second connectors, the first connector comprising a first plurality of conductive elements fixedly disposed in a first housing holding and a first shielding member disposed outside an inner body of the first housing, the second connector comprising a second plurality of conductive elements movably disposed in a second housing and a second shielding member disposed outside an inner body of the second housing. The method may include inserting the inner body of the first housing into a chamber of the inner body of the second housing; and moving the inner body of the second housing and/or the second plurality of conductive elements until the first and second connectors are mated with each other.

Optionally, the second housing of the second connector comprises a plurality of tongues disposed in the chamber of the inner body of the second housing; inserting the inner body of the first housing comprises inserting the plurality of tongues of the second housing of the second connector into the inner body of the first housing; the second shielding member of the second connector comprises an elastic arm engaging a board lock of the second connector; and moving the inner body of the second housing and/or the second plurality of conductive elements comprises moving the elastic arm relative to the board lock while maintaining contact between the elastic arm and the board lock.

Some embodiments relate to a floating electrical connector system. The electrical connector system may include a first connector, a second connector, and a board lock. The first connector may include a first housing, a first terminal assembly and a first shielding member connected to the first housing. The first shielding member may at least partially enclose the first terminal assembly. A first contact pin for grounding connection may extend from the first shielding member. The second connector may include a second housing, a second terminal assembly and a second shielding member connected to the second housing. The second shielding member may enclose the second terminal assembly. The second shielding member may be connected to the first shielding member through a connecting portion. The second shielding member may be provided with a cavity. The cavity may have an opening. A elastic arm may extend from the second shielding member in a direction away from the opening. During the extension process, the elastic arm may first bend in a direction close to the cavity to form a first portion, and then bend in a direction away from the cavity to form a second portion. The second portion may protrude at an end in a direction close to the opening to form a contact portion. The board lock may be disposed in two ends of the second housing. The board lock may include a board lock body. One end of the board lock body may bend in a direction close to the cavity to form a first contact portion. A space may be between the first contact portion and the board lock body. A second contact portion may extend from the first contact portion above the space in a direction away from the cavity. The first contact portion and the second contact portion may form together a contact region on a bottom surface. The second portion may be movably disposed in the space. The contact portion may always abut against the contact region. A second contact pin for grounding connection may extend from the other end of the board lock body. The first terminal assembly and the second terminal assembly may be connected as the first connector and the second connector are mated with each other for connection.

Optionally, the second housing comprises a chamber; the first housing comprises a protruding inner housing body, and the first shielding member is disposed outside of the inner housing body; and as the inner housing body is disposed into the chamber, the first shielding member is connected to the second shielding member.

Optionally, the connecting portion is formed by the second shielding member extending toward the cavity, and the connecting portion comprises a mating arm protruding toward the inner housing body.

Optionally, the first portion abuts against the second housing.

Optionally, the second housing comprises a first protrusion configured to limit the movement of the elastic arm, the first protrusion protrudes in a direction where the board lock is located and comprises a recessed first groove, and the elastic arm is retained within the first groove.

Optionally, a side wall of the second housing is further provided with a second protrusion, and the second shielding member is positioned between the second protrusion and a side wall of the second housing.

Optionally, the second housing comprises an outer housing body and an inner housing body disposed in the outer housing body; the outer housing body comprises an end portion, the end portion comprises a slot and a body, the board lock is disposed in the slot, and the space is enclosed in the body; and one side of the body is open toward the inner housing body, the first protrusion at the inner housing body is movably constrained within the body, and the elastic arm moves relative to the first contact portion.

Optionally, the second shielding member comprises second shielding segments respectively disposed on two sides of the inner housing body, the cavity is surrounded and formed by the second shielding segments, and the elastic arm extends from one end of the second shielding segments.

Optionally, the second terminal assembly comprises several second terminals, and the second terminal is an elastic structure comprising at least one bend.

Optionally, the second terminal assembly comprises several second terminals, the first terminal assembly comprises several first terminals, the first terminal and the second terminal are each provided with a mating end and an intermediate portion, and a thickness of the mating end of the first terminal and/or the second terminal is less than a thickness of the intermediate portion.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of a floating electrical connector system comprising a first connector and a second connector, according to some embodiments.

FIG. 2 is an exploded perspective view of the first connector of the connector system of FIG. 1.

FIG. 3 is an exploded perspective view of the second connector of the connector system of FIG. 1.

FIG. 4 is a perspective view of a board lock of the second connector of FIG. 3.

FIG. 5 is an elevation view of the second connector of FIG. 3, showing the board lock and a second shielding member in a rest state.

FIG. 6 is an elevation view of the second connector of FIG. 3, showing the board lock and the second shielding member in an offset state.

FIG. 7 is a partial cross-sectional view of the second connector of FIG. 6 along a line marked “6/7-6/7” in FIG. 6, showing the board lock and the second shielding member at a first end of the second connector.

FIG. 8 is a partial cross-sectional view of the second connector of FIG. 7 along a line marked “6/7-6/7” in FIG. 6, showing another board lock and the second shielding member at a second end of the second connector.

FIG. 9 is a perspective view of the first connector of the connector system of FIG. 1.

FIG. 10 is a perspective view of the second connector of FIG. 2.

FIG. 11 is a cross-sectional view of the connector system of FIG. 1 along a line marked “11-11” in FIG. 10.

FIG. 12 is a perspective view of a portion of the second shielding member of the second connector of FIG. 2.

FIG. 13 is a perspective view of a second housing of the second connector of FIG. 2, showing exploded inner and outer housing bodies.

FIG. 14 is a perspective view of the second shielding member of the second connector of FIG. 2.

FIG. 15 is a perspective view of second signal terminals of the second connector of FIG. 2.

FIG. 16 is a perspective view of a portion of the second signal terminals within a circle marked by “A” in FIG. 15.

FIG. 17 is a perspective view of second power terminals of the second connector of FIG. 2.

### DETAILED DESCRIPTION

The inventors have recognized and appreciated techniques for making board-to-board connectors capable of providing both high-frequency signal transmission and high-current power transmission for use in a harsh environment such as one presented by an automobile. Techniques described herein may enable connectors that have signal terminals capable of satisfying PCIe Gen 4.0's signal transmission requirements at 16 Gbps, and power terminals capable of carrying a high current (e.g., 13.75 A), while satisfying reliability requirements of industry standards (e.g., USCAR-2-V2) with floating terminals configured to move in response to manufacturing and/or assembly variations, as well as vibrations or interference encountered in the field. Techniques described herein may also enable a connector system capable of reliably operating in a range of heights. For example, a first connector may be configured for inserting into a second connector in a mating direction by a distance that can vary in a range of 0 to 0.60 mm. For example, if the nominal mating height (fully mated) of a system is 23.00 mm, the system can operate reliably in a mating height range of 23.00 mm to 23.60 mm.

According to aspects of the present disclosure, a board-to-board connector system may include first and second connectors. In some embodiments, the connectors may be mounted to circuit boards, respectively, and then mated to electrically connect the circuit boards. The connectors may be configured to allow for ±1.0 mm floating tolerance during mating to accommodate manufacturing and/or assembling variations, as well as vibrations or interference encountered in the field.

In some embodiments, an electrical connector may include a housing with an outer body and an inner body, and terminals held by the inner body. The terminals may include both signal terminals and power terminals disposed on opposite sides of the signal terminals. A shielding member may be disposed outside the inner body to surround the terminal mating ends. The shielding member may be configured to mate with a shielding member of a mating connector so as to establish a holistic shielding system between mated connectors. In some embodiments, the shielding member may include contact pins configured to mount to a circuit board. In some embodiments, the electrical connector may include one or more board locks held by the outer body of the housing and configured to mount to a circuit board.

In some embodiments, the inner body of the housing may be movable relative to the outer body of the housing in a plane perpendicular to a mating direction. The terminals may be configured to expand and contract in the mating direction, and to move transversely relative to the mating direction along with the inner body of the housing. The shielding member may include elastic arms that are movable relative to respective board locks and yet configured to maintain contact with respective board locks.

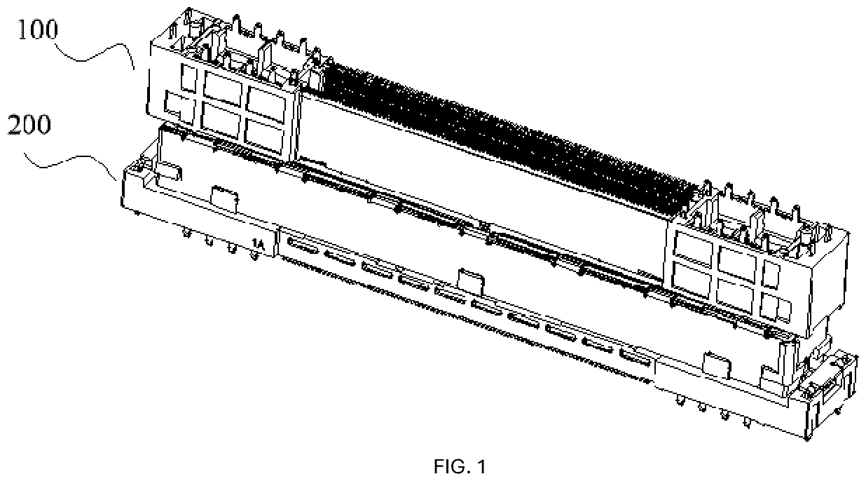

FIG. 1 illustrates a floating electrical connector system comprising a first connector 100 and a second connector 200. A shielding system may be formed between the first connector 100 and the second connector 200, providing structural stability and enhanced electromagnetic interference protection.

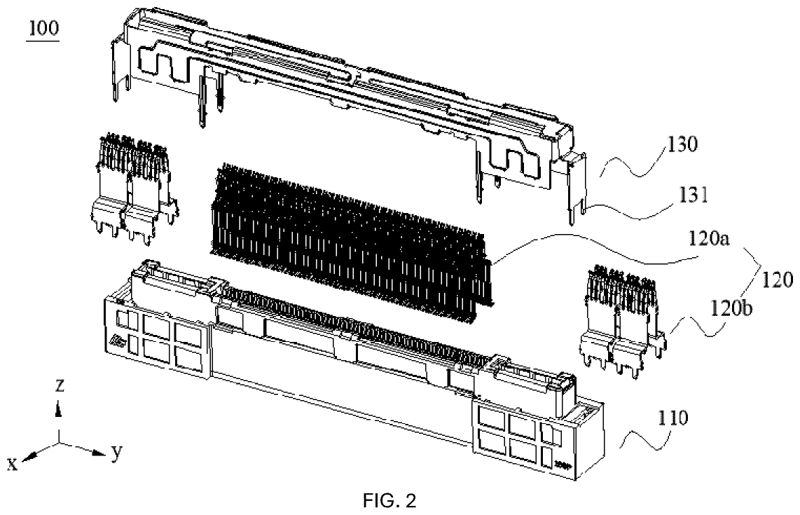

FIG. 2 shows an exploded perspective view of the first connector 100. In the illustrated example, the first connector 100 includes a first housing 110, a first terminal assembly 120, and a first shielding member 130. The first terminal assembly 120 is held by the first housing 110. The first terminal assembly 120 includes several first terminals. The first terminals may include first signal terminals 120a and first power terminals 120b. To reduce external interference with the first terminals, the first shielding member 130 is disposed on the first housing 110 and encloses the first terminal assembly 120. A first contact pin 131 extends from the first shielding member 130 and is configured to connect to a PCB or other structures to provide grounding.

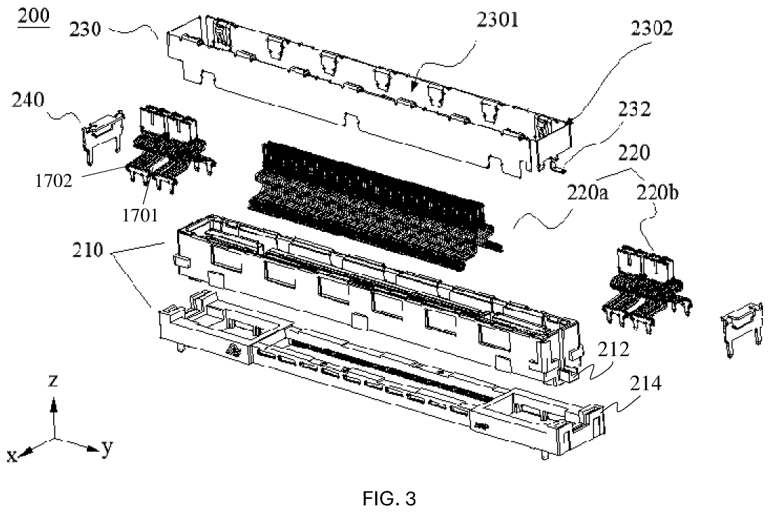

FIG. 3 shows an exploded perspective view of the second connector 200. In the illustrated example, the second connector 200 includes a second housing 210, a second terminal assembly 220, a second shielding member 230, and a board lock 240. The second terminal assembly 220 is held by the second housing 210. The second terminal assembly 220 includes several second terminals. The second terminals may include second signal terminals 220a and second power terminals 220b. To reduce external interference with the second terminals, the second shielding member 230 is disposed on the second housing 210 and encloses the second terminal assembly 220.

The second shielding member 230 may be configured to connect to the board lock 240, thereby directing electromagnetic fields and similar factors to ground or other shielding members, further reducing interference with signal transmission. The second shielding member 230 includes an extended elastic arm 232, which may be configured to connect to the board lock 240.

As illustrated, the second shielding member 230 comprises a cavity 2301 for accommodating the second housing 210, and the cavity 2301 has an opening 2302. The elastic arm 232 extends in a direction away from the opening 2302 and bends toward the board lock 240.

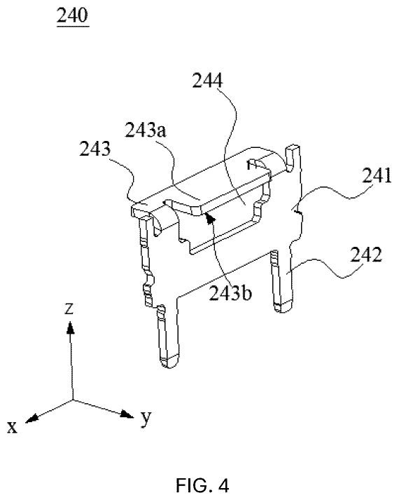

FIG. 4 shows a perspective view of the board lock 240. In the illustrated example, the board lock 240 includes a board lock body 241. The board lock body 241 may have a sheet-like structure. Two second contact pins 242 for grounding extend outward from one end of the board lock body, while the other end comprises a first contact portion 243 configured to contact the elastic arm 232. A space 244 is between the first contact portion 243 and the board lock body 241 to allow movement of the elastic arm 232.

A second contact portion 243a extends from the first contact portion 243 and above the space 244 in the opposite direction away from the cavity 2301. The first contact portion 243 and the second contact portion 243a together may form a contact region 243b on a bottom surface. The elastic arm 232 of the second shielding member 230 is movably disposed in the space 244. An end of the elastic arm 232 may be configured to remain abutting against the contact region 243b. When the floating electrical connector system shifts or deforms due to external forces, the elastic arm 232 may move in the space 244 while maintaining contact with the contact region 243b of the board lock, thereby enhancing the stability of the grounding structure.

An example illustrating how the elastic arm 232 and the board lock 240 maintain a floating connection is described below.

In the illustrated embodiment, the board lock 240 is parallel to a side wall of the second housing 210. The extension direction of the side wall of the second housing 210 may be referred to as an X direction, while the extension direction of an adjacent side wall of the second housing 210 may be referred to as a Y direction. The second housing 210 is elongated in the Y direction. A Z direction may be perpendicular to both the X and Y directions.

In some embodiments, the space 244 may be a space semi-enclosed formed by a contact portion (which may include the first contact portion 243 and the second contact portion 243a) and the board lock body 241. For example, the contact portion may be integrally formed with the board lock body 241. The space 244 may be formed by bending the contact portion relative to the board lock body 241. In the illustrated embodiment, the space 244 is between the contact portion and the board lock body 241 and extends through the board lock body 241. The space 244 extends in the X direction, with the contact portion positioned above the space 244 and extending in the same direction.

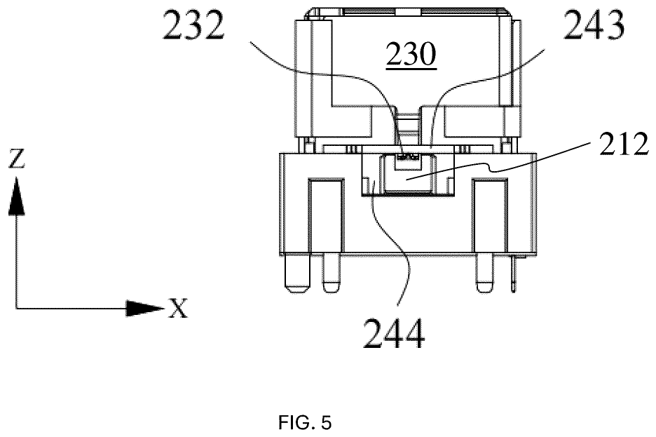

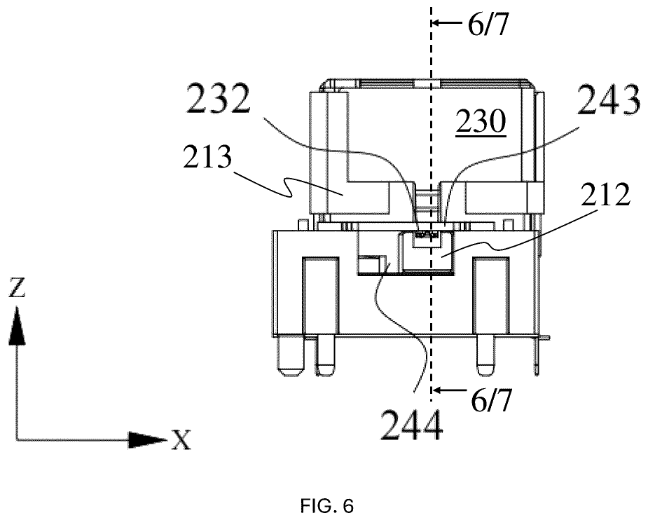

FIG. 5 is an elevation view of the second connector 200, showing the board lock 240 and the second shielding member 230 in a rest state. FIG. 6 is an elevation view of the second connector 200, showing the board lock 240 and the second shielding member 230 in an offset state. As illustrated, in the rest state, an end of the elastic arm 232 is disposed in the space 244, and connected to the first contact portion 243. When the second connector 200 is subject to external forces and the second shielding member 230 moves relative to the board lock 240 in the X direction, the elastic arm 232 slides in the space 244 while maintaining continuous contact with the first contact portion 243 throughout the sliding process.

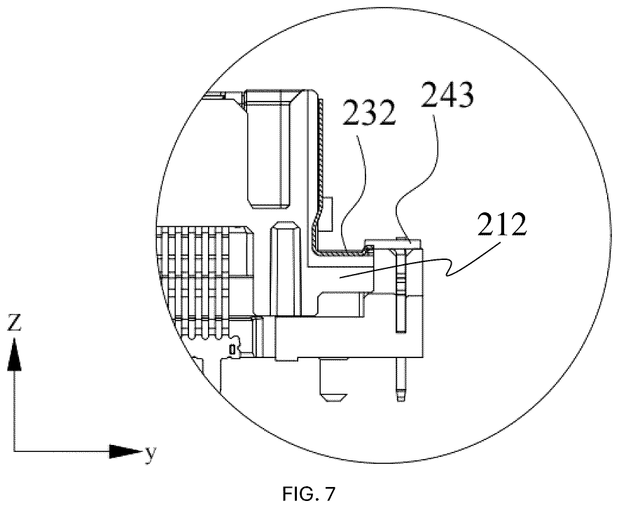

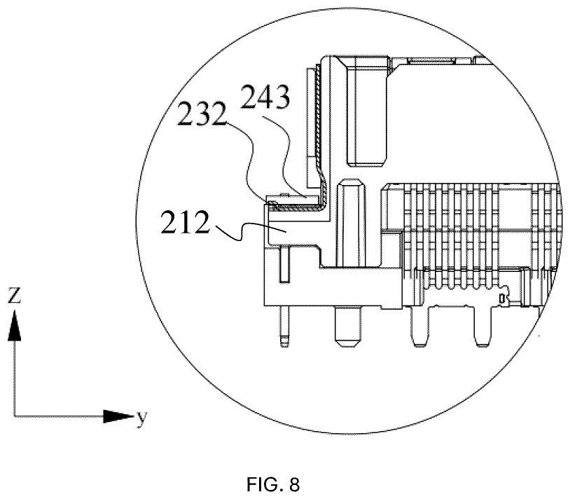

FIGS. 7-8 are partial cross-sectional views of opposite ends of the second connector 200 in an offset state, showing the second shielding member 230 moves in the Y direction. When the second shielding member 230 moves in the Y direction, one end of the second shielding member 230 moves toward the exterior of the second housing 210, while the other end moves away from the exterior of the second housing 210. To ensure that the end of the elastic arm 232 maintains contact with the first contact portion 243 during the movement of the second shielding member 230 in the Y direction, the first contact portion 243 and the second contact portion 243a protrude from opposite sides of the board lock body 241. This increases the contactable area of the first contact portion 243 in the Y direction, thereby enhancing the structural stability between the second shielding member 230 and the board lock 240.

In the Z direction, the extension direction of the space 244 may be configured to accommodate the elastic arm 232, ensuring that the elastic arm 232 maintains contact with the first contact portion 243 as the second shielding member 230 moves relative to the board lock 240.

As described herein, the second shielding member 230 and the board lock 240 can maintain contact during relative displacement, thereby enhancing shielding stability.

A connecting portion 234 may be provided between the first shielding member 130 and the second shielding member 230. When the first connector 100 is mated with the second connector 200, the first shielding member 130 and the second shielding member 230 may be connected through the connecting portion 234.

The first shielding member 130, the second shielding member 230, and the board lock 240 may together form a complete shielding system. The shielding system not only provides individual shielding for the first connector 100 and the second connector 200, but also ensures a stable grounding connection through the floating connection structure between the second shielding member 230 and the board lock 240. By maintaining continuity between the shielding members of the first connector 100 and the second connector 200, the system prevents degradation of the shielding effect that may be caused by looseness or vibration at the connection.

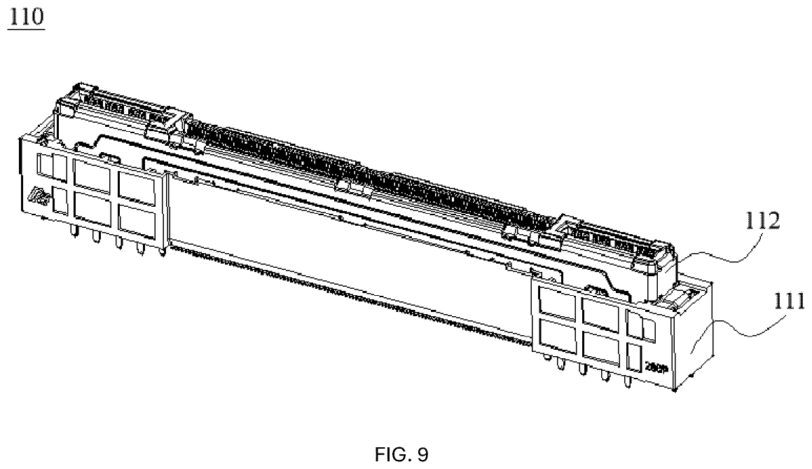

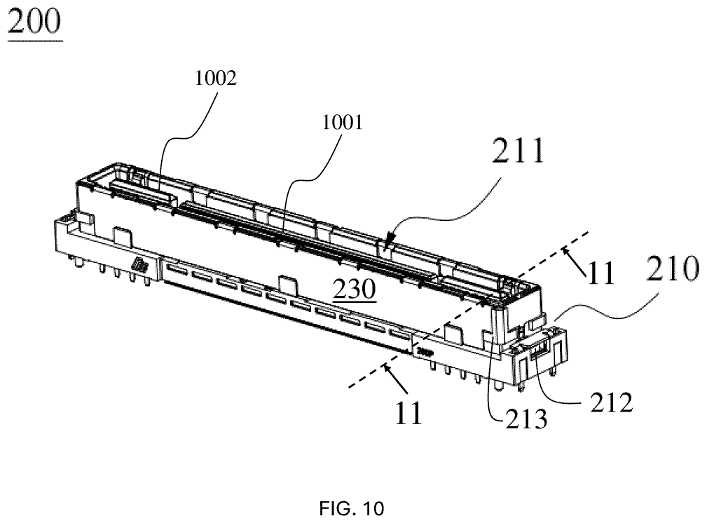

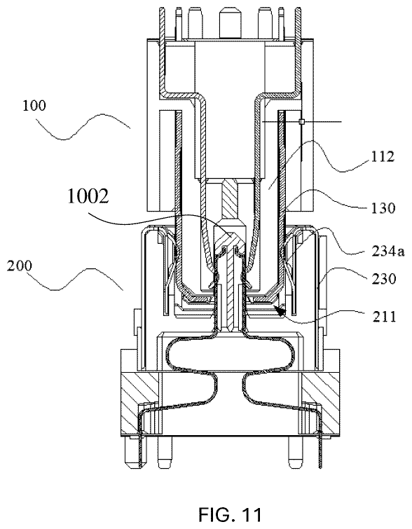

In some embodiments, to enhance the shielding effect at the connection between the first connector 100 and the second connector 200, the first housing 110 of the first connector 100 and the second housing 210 of the second connector 200 are inserted into each other. FIG. 9 is a perspective view of the first connector 100. FIG. 10 is a perspective view of the second connector 200. FIG. 11 is a cross-sectional view of the connector system comprising the first connector 100 and the second connector 200 along a line marked “11-11” in FIG. 10.

In the illustrated example, the first housing 110 includes an outer housing body 111 and an inner housing body 112 protruding relative to the outer housing body 111. The inner housing body 112 may be partially located inside the outer housing body 111, and the outer housing body 111 and the inner housing body 112 may be integrally molded. The first terminal assembly 120 is disposed in the inner housing body 112, the first shielding member 130 is disposed between an exterior side wall of the inner housing body 112 and the outer housing body 111, and a first contact pin 131 extending from the first shielding member 130 passes through the outer housing body 111 to facilitate connection with a structure such as a PCB board.

Correspondingly, a chamber 211 configured to accommodate the inner housing body 112 is formed in the second housing 210, the second terminal assembly 220 is disposed in the chamber 211, and the second shielding member 230 encloses the outside of the chamber 211. When the first connector 100 and the second connector 200 are connected, the inner housing body 112 is disposed into the chamber 211, and the first terminal assembly 120 is connected to the second terminal assembly 220. Also, the first shielding member 130 and the second shielding member 230 are connected through the connecting portion 234.

In the illustrated example, the inner housing body 210b of the second housing 210 includes multiple tongues disposed in the chamber 211. The tongues may include a first tongue 1001, and second tongues 1002 disposed on opposite sides of the first tongue 1001 and spaced from the first tongue 1001. The mating ends of the second signal terminals 220a are disposed along opposite sides of the first tongue 1001. The mating ends of the second power terminals 220b are disposed along opposite sides of a respective second tongue 1002.

The first shielding member 130 is disposed into the chamber 211 along with the inner housing body 112, and the second shielding member 230 encloses the chamber 211, realizing complete shielding of the connection between the first connector 100 and the second connector 200, and effectively enhancing interference prevention during use.

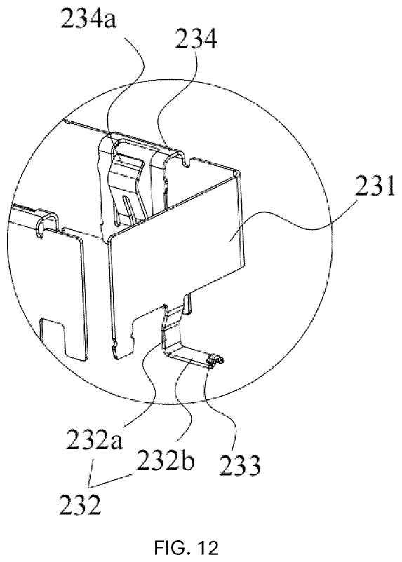

The connecting portion 234 may be disposed on the first shielding member 130 or the second shielding member 230. In the illustrated embodiment, the connecting portion 234 is formed by extending the second shielding member 230 toward the cavity 2301. FIG. 12 shows a perspective view of a portion of the second shielding member 230 of the second connector 200. With reference to FIGS. 10 and 12, the connecting portion 234 extends from the second shielding body 231 into the chamber 211 and is close to the inner side wall of the chamber 211. The connecting portion 234 includes a mating arm 234a protruding toward the inner housing body 112. The mating arm 234a is a curved elastic structure. When the inner housing body 112 of the first connector 100 is disposed into the chamber 211, the mating arm 234a is connected to the first shielding member 130 outside the inner housing body 112, realizing the connection between the first shielding member 130 and the second shielding member 230, so as to form a complete shielding system. The elastic structure of the mating arm 234a may contribute to improved connection stability of the shielding system.

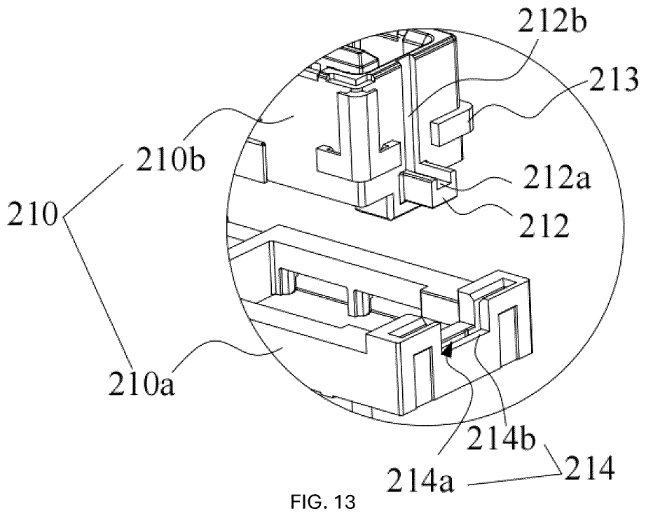

The second housing 210 may include a limiting structure for the second shielding member 230 so as to enhance the structural stability of the shielding system. FIG. 13 is a perspective view of the second housing 210. In the illustrated example, the second housing 210 comprises a first protrusion 212 configured to limit the movement of the elastic arm 232. The first protrusion 212 protrudes from the second housing 210 toward the board lock 240, and the first protrusion 212 is recessed to form a first groove 212a, and the elastic arm 232 is retained within the first groove 212a. The elastic arm 232 includes a first portion 232a and a second portion 232b. The first portion 232a extends in a direction parallel to a side wall of the second housing 210, and is bent toward the cavity. The second portion 232b is bent relative to the first portion 232a in a direction away from the cavity 2301. For example, an end of the second portion 232b may further be provided with a contact portion 233, and the contact portion 233 abuts against the first contact portion 243 to increase the stability and conductivity of the connection between the second shielding member 230 and the board lock 240.

The second portion 232b is retained within the first groove 212a, effectively preventing the connection between the second shielding member 230 and the board lock 240 from loosening or disconnecting due to deformation of the second portion 232b under external forces.

In some embodiments, the second housing 210 may further include a second groove 212b in communication with the first groove 212a, and the second groove 212b is configured to securely position and restrict the movement of the first portion 232a. For example, the first portion 232a is an elastic structure bent toward the second housing 210, so that the elastic arm 232 has a buffering characteristic in terms of structure, further increasing the stability of the connection between the second shielding member 230 and the board lock 240. In the illustrated embodiment, the first portion 232a abuts against the second housing 210.

In some embodiments, the exterior side wall of the second housing 210 is further provided with a second protrusion 213 for securing the second shielding body 231, and the second protrusion 213 and the outer side portion of the second housing 210 form a space that accommodates the second shielding body 231. The second shielding body 231 may further be provided with a snap-on structure, which is fixed to the second housing 210 and forms an interference fit with the inner housing body 112.

In some embodiments, the second housing 210 includes an outer housing body 210a and an inner housing body 210b disposed inside the outer housing body 210a, and the inner housing body 210b protrudes relative to the outer housing body 210a. The second shielding member 230 is disposed on the exterior side wall of the inner housing body 210b through the first protrusion 212 and the second protrusion 213. The first protrusion 212 extends from the inner housing body 210b and is located between the outer housing body 210a and the inner housing body 210b. The board lock 240 is disposed on the outer housing body 210a.

The outer housing body 210a comprises an end portion 214, and the end portion 214 includes a slot 214a that penetrates the outer housing body 210a. A second contact pin 242 located at one end of the board lock 240 passes through the slot 214a to facilitate connection with a structure such as a PCB board, and one end provided with the first contact portion 243 and the space 244 is connected to the elastic arm 232.

In some embodiments, the end portion 214 may further include a body 214b. After the board lock 240 is disposed on the outer housing body 210a, the space 244 is enclosed in the body 214b. One side of the body 214b is open toward the inner housing body 210b to facilitate the plugging and movement of the first protrusion 212. In the illustrated embodiment, the body 214b extends in the Y direction, penetrates the inner and outer sides of the outer housing body 210a, and is in communication with the third limit slot 214a. In the X direction, the body 214b is configured to accommodate the space 244. In the Y direction, the body 214b is configured to accommodate the first contact portion 243, and the first contact portion 243 does not protrude from the exterior side wall of the outer housing body 210a. With the influence of external vibration and other factors, the second protrusion 213 of the first connector 100 may move relatively in the X and Y directions along the body 214b, thereby always maintaining the connection between the elastic arm 232 and the first contact portion 243. In addition, the provision of the body 214b and the space 244 expands the movement range of the second protrusion 213 and the connecting portion in the X and Y directions, and reduces the touch of the board lock 240 and the elastic arm 232 with the outside world, thereby effectively improving the anti-interference ability and ensuring the stability of the structural connection.

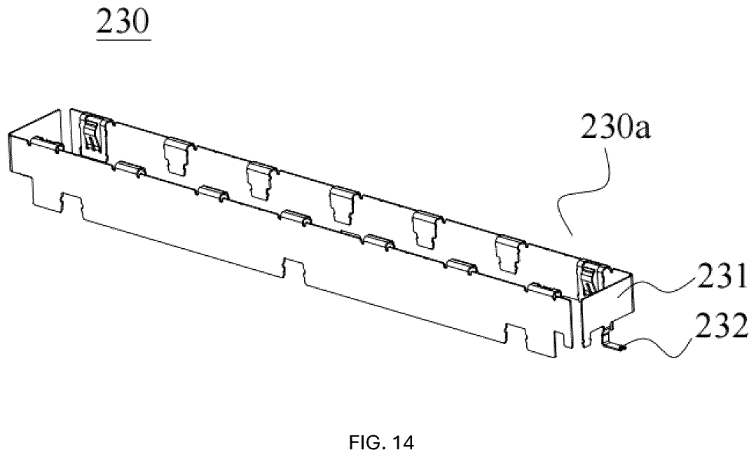

FIG. 14 is a perspective view of the second shielding member 230. In the illustrated embodiment, the second shielding member 230 includes second shielding segments 230a respectively disposed on two sides of the inner housing body 210b, and the second shielding segment 230a includes a second shielding body 231 and an elastic arm 232 extending from the second shielding body 231. A cavity 2301 is surrounded and formed by two second shielding segments 230a.

In the illustrated embodiment, the second shielding segments 230a are symmetrically disposed on two sides of the inner housing body 210b, wherein the second shielding segment 230a is an L-shaped structure as a whole and is connected to two adjacent side walls of the inner housing body 210b. The second shielding segments 230a disposed symmetrically play the function of completely shielding the side walls around the inner housing body 210b.

One elastic arm 232 extends from each of the second shielding segments 230a.

Correspondingly, board locks 240 are symmetrically disposed on two sides of the outer housing body 210a, and are connected to the elastic arms 232 of different second shielding segments 230a, respectively.

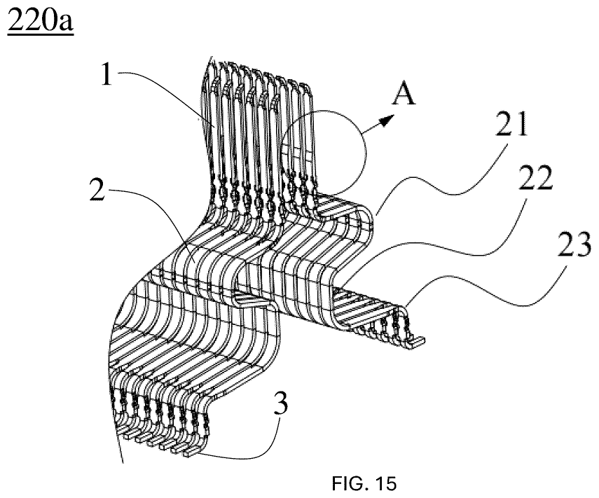

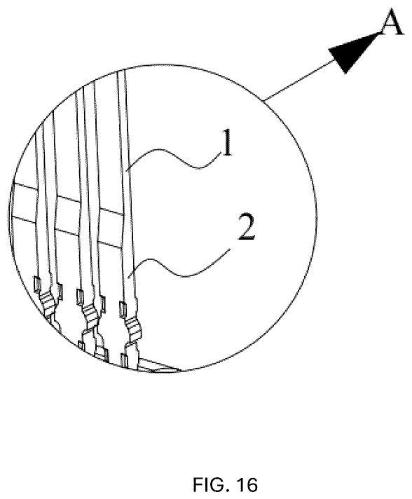

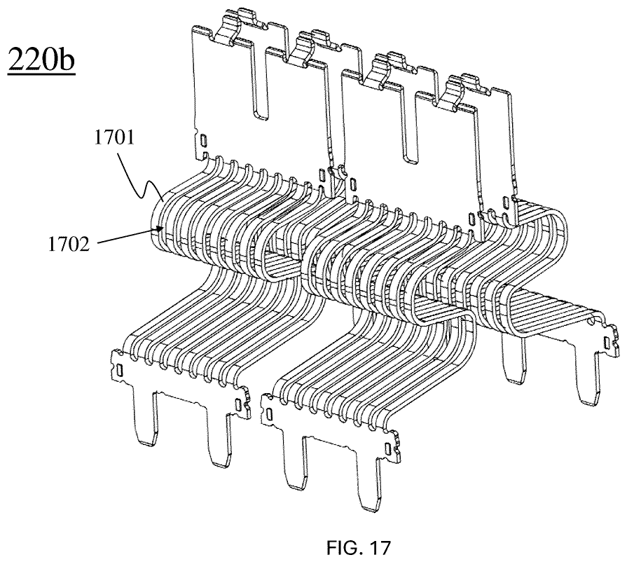

FIG. 15 is a perspective view of second signal terminals 220a of the second connector 200. FIG. 16 is a perspective view of a portion of the second signal terminals 220a within a circle marked by “A” in FIG. 15. FIG. 17 is a perspective view of second power terminals 220b of the second connector 200. In the illustrated example, the second terminal assembly 220 includes both second signal terminals 220a and second power terminals 220b. When the first connector 100 is mated with the second connector 200, the second signal terminals 220a are in electrical communication with the first signal terminals 120a, and the second power terminals 220b are in electrical communication with the first power terminals 120b.

Each terminals may include a mating end 1, a tail end 3, and an intermediate portion 2 between the mating end 1 and tail end 3. The thickness of the mating end 1 may be less than the thickness of the intermediate portion 2, thereby reducing impedance discontinuity at the connection interface between different terminals and avoiding the resulting degradation in transmission rate. Such a configuration may enable the connector to satisfy PCIe Gen 4.0's signal transmission requirements of 16 Gbps. In some embodiments, the mating ends 1 of either the first terminal or the second terminal may be thinned.

The second terminals may be configured to expand and contract in the mating direction, and to move transversely relative to the mating direction along with the inner housing body 210b of the second housing 210. Each second terminal may have an elastic structure including at least one bend.

As shown in FIG. 15, the intermediate portion 2 of each second signal terminal 220a includes a first bending portion 21, a second bending portion 22, and a third bending portion 23. Each bend may enable elastic deformation of the second signal terminal, allowing it to elongate and extend for stress distribution. The terminal may return to its original state after deformation caused by external vibration or interference, thereby preventing a loose connection between the first terminal assembly 120 and the second terminal assembly 220, and accommodating variations in mating height.

As shown in FIG. 17, the intermediate portion 2 of each second power terminal 220b includes multiple segments 1701 and gaps 1702 disposed between adjacent segments 1701. Each segment 1701 may be configured similarly to the intermediate portion 2 of each second signal terminal 220a, such that the second power terminals 220b may move in a comparable manner to the second signal terminals 220a.

Various aspects are described in this disclosure, which include, but are not limited to, the following aspects:

1. A floating electrical connector system comprising: a first connector (e.g., 100), comprising a first housing (e.g., 110), and a first terminal assembly (e.g., 120) and a first shielding member (e.g., 130) connected to the first housing (e.g., 110), wherein the first shielding member (e.g., 130) encloses the first terminal assembly (e.g., 120), and a first contact pin (e.g., 131) for grounding connection extends from the first shielding member (e.g., 130); a second connector (e.g., 200), comprising a second housing (e.g., 210), and a second terminal assembly (e.g., 220) and a second shielding member (e.g., 230) connected to the second housing (e.g., 210), wherein the second shielding member (e.g., 230) encloses the second terminal assembly (e.g., 220), and the second shielding member (e.g., 230) is connected to the first shielding member (e.g., 130) through a connecting portion (e.g., 234); the second shielding member (e.g., 230) comprises a cavity (e.g., 2301), the cavity (e.g., 2301) has an opening (e.g., 2302), and an elastic arm (e.g., 232) extends from the second shielding member (e.g., 230) in a direction away from the opening (e.g., 2302); during the extension process, the elastic arm (e.g., 232) is first bent in a direction close to the cavity (e.g., 2301) to form a first portion (e.g., 232a), and then bent in a direction away from the cavity (e.g., 2301) to form a second portion (e.g., 232b); and the second portion (e.g., 232b) protrudes at an end in a direction close to the opening (e.g., 2302) to form a contact portion (e.g., 233); and a board lock (e.g., 240) disposed in two ends of the second housing (e.g., 210), wherein the board lock (e.g., 240) comprises a board lock body (e.g., 241), one end of the board lock body (e.g., 241) is bent in a direction close to the cavity (e.g., 2301) to form a first contact portion (e.g., 243), a space (e.g., 244) is between the first contact portion (e.g., 243) and the board lock body (e.g., 241), a second contact portion (e.g., 243a) extends from the first contact portion (e.g., 243) above the space (e.g., 244) in a direction away from the cavity (e.g., 2301), and the first contact portion (e.g., 243) and the second contact portion (e.g., 243a) together form a contact region (e.g., 243b) on a bottom surface; the second portion (e.g., 232b) is movably disposed in the space (e.g., 244), and the contact portion (e.g., 233) always abuts against the contact region (e.g., 243b); and a second contact pin (e.g., 242) for grounding connection extends from the other end of the board lock body (e.g., 241); wherein the first terminal assembly (e.g., 120) and the second terminal assembly (e.g., 220) are connected as the first connector (e.g., 100) and the second connector (e.g., 200) are mated with each other for connection.

2. The floating electrical connector system of aspect 1, wherein the second housing (e.g., 210) comprises a chamber (e.g., 211); the first housing (e.g., 110) comprises a protruding inner housing body (e.g., 112), and the first shielding member (e.g., 130) is disposed outside of the inner housing body (e.g., 112); and as the inner housing body (e.g., 112) is disposed into the chamber (e.g., 211), the first shielding member (e.g., 130) is connected to the second shielding member (e.g., 230).

3. The floating electrical connector system of aspect 2, wherein the connecting portion (e.g., 234) is formed by the second shielding member (e.g., 230) extending toward the cavity (e.g., 2301), and the connecting portion (e.g., 234) comprises a mating arm (e.g., 234a) protruding toward the inner housing body (e.g., 112).

4. The floating electrical connector system of aspect 1, wherein the first portion (e.g., 232a) abuts against the second housing (e.g., 210).

5. The floating electrical connector system of aspect 1, wherein the second housing (e.g., 210) comprises a first protrusion (e.g., 212), the first protrusion (e.g., 212) protrudes in a direction where the board lock (e.g., 240) is located and comprises a recessed first groove (e.g., 212a), and the second portion (e.g., 232b) is retained within the first groove (e.g., 212a).

6. The floating electrical connector system of aspect 5, wherein a side wall of the second housing (e.g., 210) is further provided with a second protrusion (e.g., 213), and the second shielding member (e.g., 230) is positioned between the second protrusion (e.g., 213) and a side wall of the second housing (e.g., 210).

7. The floating electrical connector system of aspect 6, wherein the second housing (e.g., 210) comprises an outer housing body (e.g., 210a) and an inner housing body (e.g., 210b) located inside the outer housing body (e.g., 210a); the outer housing body (e.g., 210a) comprises an end portion (e.g., 214), the end portion (e.g., 214) comprises a slot (e.g., 214a) and a body (e.g., 214b), the board lock (e.g., 240) is disposed in the slot (e.g., 214a), and the space (e.g., 244) is enclosed in the body (e.g., 214b); and one side of the body (e.g., 214b) is open toward the inner housing body (e.g., 210b), the first protrusion (e.g., 212) at the inner housing body (e.g., 210b) is movably constrained within the body (e.g., 214b), and the elastic arm (e.g., 232) moves relative to the first contact portion (e.g., 243).

8. The floating electrical connector system of any one of aspects 1-7, wherein the second shielding member (e.g., 230) comprises second shielding segments (e.g., 230a) respectively disposed on two sides of the inner housing body (e.g., 210b), the cavity (e.g., 2301) is surrounded and formed by the second shielding segments (e.g., 230a), and the elastic arm (e.g., 232) extends from one end of the second shielding segment (e.g., 230a).

9. The floating electrical connector system of aspect 1, wherein the second terminal assembly (e.g., 220) comprises several second terminals, and the second terminal is an elastic structure comprising at least one bend.

10. The floating electrical connector system of aspect 1, wherein the second terminal assembly (e.g., 220) comprises several second terminals, the first terminal assembly (e.g., 120) comprises several first terminals, the first terminal and the second terminal are each provided with a mating end (e.g., 1) and an intermediate portion (e.g., 2), and a thickness of the mating end (e.g., 1) of the first terminal and/or the second terminal is less than a thickness of the intermediate portion (e.g., 2).

11. An electrical connector (e.g., 100, 200) comprising a housing (e.g., 110, 210) comprising an outer housing body, and an inner housing body disposed in the outer housing body and extending beyond the outer housing body in a mating direction; a plurality of conductive elements (e.g., 120, 220) held by the inner housing body, each of the plurality of conductive elements comprising a mating end disposed in the inner housing body, a tail end extending out of the inner housing body, and an intermediate portion between the mating end and the tail end, the plurality of conductive elements comprising a plurality of signal terminals and a plurality of power terminals disposed on opposite sides of the plurality of signal terminals; and a shielding member (e.g., 130, 230) disposed outside the inner housing body and surrounding at least the mating ends of the plurality of conductive elements.

12. The electrical connector (e.g., 200) of aspect 11, wherein the inner housing body (e.g., 210b) is movable relative to the outer housing body (e.g., 210a).

13. The electrical connector of aspect 12, comprising one or more board locks (e.g., 240), each of the one or more board locks comprising a board lock body (e.g., 241) disposed in the outer housing body, a contact portion (e.g., 243) connected to the board lock body and disposed above the outer housing body, and a space (e.g., 244) between the board lock body and the contact portion, wherein the shielding member comprises one or more elastic arms (e.g., 232); and each of the one or more elastic arms is movably disposed in the space of a respective board lock and configured to maintain contact with the contact portion of the respective board lock when the inner housing body moves relative to the outer housing body.

14. The electrical connector of aspect 13, wherein the outer housing body comprises first and second end portions (e.g., 214) disposed on opposite sides of the inner housing body; the one or more board locks are first and second board locks disposed in the first and second end portions of the outer housing body, respectively; and the one or more elastic arms are first and second elastic arms movably disposed in the spaces of the first and second board locks, respectively, and configured to maintain contact with the contact portions of the first and second board locks, respectively.

15. The electrical connector of aspect 12, wherein the inner housing body comprises a chamber (e.g., 211) configured to receive a mating component; and the shielding member comprises a plurality of mating arms (e.g., 234a) curving into the chamber and configured to contact with the mating component.

16. The electrical connector of aspect 15, wherein the inner housing body comprises a plurality of tongues (e.g., 1001, 1002) disposed in the chamber; the plurality of tongues comprise a first tongue (e.g., 1001), and second tongues (e.g., 1002) disposed on opposite sides of the first tongue and spaced from the first tongue; the mating ends of the plurality of signal terminals (e.g., 220a) are disposed along opposite sides of the first tongue; the mating ends of the plurality of power terminals (e.g., 220b) are disposed along opposite sides of a respective second tongue; and the plurality of mating arms are disposed offset from the plurality of signal terminals.

17. The electrical connector of aspect 15, wherein the intermediate portion of each of the plurality of signal terminals comprises a plurality of bending portions (e.g., 21, 22, 23); and the intermediate portion of each of the plurality of power terminals comprises a plurality of segments (e.g., 1701) and a plurality of gaps (e.g., 1702) disposed between adjacent segments, each of the plurality of segments comprising a plurality of bending portions.

18. The electrical connector (e.g., 100) of aspect 11, wherein the inner housing body (e.g., 112) and the outer housing body (e.g., 111) are integrally formed as a unitary component.

19. The electrical connector of aspect 18, wherein the shielding member comprises a portion disposed between the inner housing body and the outer housing body, and contact pins (e.g., 131) extending from the portion and out of the housing.

20. An electrical connector (e.g., 200) comprising a housing (e.g., 210) comprising an outer housing body (e.g., 210a), and an inner housing body (e.g., 210b) disposed in the outer housing body and movable relative to the outer housing body; a plurality of conductive elements (e.g., 220) held by the inner housing body, each of the plurality of conductive elements comprising a mating end (e.g., 1) disposed in the inner housing body, a tail end (e.g., 3) extending out of the inner housing body, and an intermediate portion (e.g., 2) between the mating end and the tail end; a board lock (e.g., 240) comprising a board lock body (e.g., 241) disposed in the outer housing body, a contact portion (e.g., 243) connected to the board lock body, and a space (e.g., 244) between the board lock body and the contact portion; and a shielding member disposed outside the inner housing body, the shielding member (e.g., 230) comprising a shielding body (e.g., 231), and an elastic arm (e.g., 232) extending from the shielding body into the space of the board lock body to engage the contact portion of the board lock.

21. The electrical connector of aspect 20, wherein the outer housing body comprises an end portion (e.g., 214) shaped to accommodate the board lock, the end portion comprising a slot (e.g., 214a); the board lock body is disposed in the slot of the end portion of the outer housing body; and the inner housing body comprises a protrusion (e.g., 212) configured for retaining the elastic arm of the shielding member, the protrusion extending outwardly into the end portion of the outer housing body such that the elastic arm extends into the space of the board lock body.

22. The electrical connector of aspect 21, wherein the protrusion comprises a first groove (e.g., 212a); the inner housing body comprises a side wall comprising a second groove (e.g., 212b) connected to the first groove; and the elastic arm of the shielding member extends from the second groove into the first groove.

23. The electrical connector of aspect 22, wherein the protrusion is a first protrusion; and the side wall of the inner housing body comprises second protrusions (e.g., 213) configured for retaining the shielding body of the shielding member.

24. The electrical connector of aspect 22, wherein the protrusion is sized such the inner housing body is movable relative to the outer housing body in a plane perpendicular to a mating direction; and the plurality of conductive elements are configured to expand and contract in the mating direction, and to move transversely relative to the mating direction along with the inner housing body.

25. The electrical connector of aspect 24, wherein the plurality of conductive elements comprise a plurality of signal terminals (e.g., 220a) and a plurality of power terminals (e.g., 220b) disposed on opposite sides of the plurality of signal terminals; the intermediate portion of each of the plurality of signal terminals comprises a plurality of bending portions (e.g., 21, 22, 23); and the intermediate portion of each of the plurality of power terminals comprises a plurality of segments (e.g., 1701) and a plurality of gaps (e.g., 1702) disposed between adjacent segments, each of the plurality of segments comprising a plurality of bending portions.

26. The electrical connector of aspect 24, wherein the outer housing body comprises first and second end portions disposed on opposite sides of the inner housing body; the board lock is a first board lock held by the first end portion of the outer housing body; the electrical connector comprises a second board lock held by the second end portion of the outer housing body; and the inner housing body comprises first protrusions extending into the first and second end portions of the outer housing body, respectively.

27. The electrical connector of aspect 25, wherein the inner housing body comprises a chamber (e.g., 211) configured to receive a mating component, and a plurality of tongues disposed in the chamber; the plurality of tongues comprise a first tongue (e.g., 1001), and second tongues (e.g., 1002) disposed on opposite sides of the first tongue and spaced from the first tongue; the mating ends of the plurality of signal terminals are disposed along opposite sides of the first tongue; and the mating ends of the plurality of power terminals are disposed along opposite sides of a respective second tongue.

28. The electrical connector of aspect 20, wherein the inner housing body comprises a chamber configured to receive a mating component; and the shielding member comprises a plurality of mating arms (e.g., 234a) curving into the chamber and configured to contact with the mating component.

29. A method of operating an electrical connector system comprising first and second connectors, the first connector (e.g., 100) comprising a first plurality of conductive elements (e.g., 120) fixedly disposed in a first housing (e.g., 110) holding and a first shielding member (e.g., 130) disposed outside an inner body (e.g., 112) of the first housing, the second connector (e.g., 200) comprising a second plurality of conductive elements (e.g., 220) movably disposed in a second housing (e.g., 210) and a second shielding member (e.g., 230) disposed outside an inner body (e.g., 210b) of the second housing, the method comprising inserting the inner body of the first housing into a chamber (e.g., 211) of the inner body of the second housing; and moving the inner body of the second housing and/or the second plurality of conductive elements until the first and second connectors are mated with each other.

30. The method of aspect 29, wherein the second housing of the second connector comprises a plurality of tongues (e.g., 1001, 1002) disposed in the chamber of the inner body of the second housing; inserting the inner body of the first housing comprises inserting the plurality of tongues of the second housing of the second connector into the inner body of the first housing; the second shielding member of the second connector comprises an elastic arm (e.g., 232) engaging a board lock (e.g., 240) of the second connector; and moving the inner body of the second housing and/or the second plurality of conductive elements comprises moving the elastic arm relative to the board lock while maintaining contact between the elastic arm and the board lock.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear,” “upper,” “lower,” “left,” “right,” “transverse direction,” “vertical direction,” “perpendicular,” “horizontal,” “top,” “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10+d1 and 20+d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within +3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing comprising an outer housing body, and an inner housing body disposed in the outer housing body and extending beyond the outer housing body in a mating direction;
a plurality of conductive elements held by the inner housing body, each of the plurality of conductive elements comprising a mating end disposed in the inner housing body, a tail end extending out of the inner housing body, and an intermediate portion between the mating end and the tail end, the plurality of conductive elements comprising a plurality of signal terminals and a plurality of power terminals disposed on opposite sides of the plurality of signal terminals; and
a shielding member disposed outside the inner housing body and surrounding at least the mating ends of the plurality of conductive elements.

2. The electrical connector of claim 1, wherein:
the inner housing body is movable relative to the outer housing body.

3. The electrical connector of claim 2, comprising:
one or more board locks, each of the one or more board locks comprising a board lock body disposed in the outer housing body, a contact portion connected to the board lock body and disposed above the outer housing body, and a space between the board lock body and the contact portion, wherein:
the shielding member comprises one or more elastic arms; and
each of the one or more elastic arms is movably disposed in the space of a respective board lock and configured to maintain contact with the contact portion of the respective board lock when the inner housing body moves relative to the outer housing body.

4. The electrical connector of claim 3, wherein:
the outer housing body comprises first and second end portions disposed on opposite sides of the inner housing body;
the one or more board locks are first and second board locks disposed in the first and second end portions of the outer housing body, respectively; and
the one or more elastic arms are first and second elastic arms movably disposed in the spaces of the first and second board locks, respectively, and configured to maintain contact with the contact portions of the first and second board locks, respectively.

5. The electrical connector of claim 2, wherein:
the inner housing body comprises a chamber configured to receive a mating component; and
the shielding member comprises a plurality of mating arms curving into the chamber and configured to contact with the mating component.

6. The electrical connector of claim 5, wherein:
the inner housing body comprises a plurality of tongues disposed in the chamber;
the plurality of tongues comprise a first tongue, and second tongues disposed on opposite sides of the first tongue and spaced from the first tongue;
the mating ends of the plurality of signal terminals are disposed along opposite sides of the first tongue;
the mating ends of the plurality of power terminals are disposed along opposite sides of a respective second tongue; and
the plurality of mating arms are disposed offset from the plurality of signal terminals.

7. The electrical connector of claim 5, wherein:
the intermediate portion of each of the plurality of signal terminals comprises a plurality of bending portions; and
the intermediate portion of each of the plurality of power terminals comprises a plurality of segments and a plurality of gaps disposed between adjacent segments, each of the plurality of segments comprising a plurality of bending portions.

8. The electrical connector of claim 1, wherein:
the inner housing body and the outer housing body are integrally formed as a unitary component.

9. The electrical connector of claim 8, wherein:
the shielding member comprises a portion disposed between the inner housing body and the outer housing body, and contact pins extending from the portion and out of the housing.

10. An electrical connector comprising:
a housing comprising an outer housing body, and an inner housing body disposed in the outer housing body and movable relative to the outer housing body;
a plurality of conductive elements held by the inner housing body, each of the plurality of conductive elements comprising a mating end disposed in the inner housing body, a tail end extending out of the inner housing body, and an intermediate portion between the mating end and the tail end;
a board lock comprising a board lock body disposed in the outer housing body, a contact portion connected to the board lock body, and a space between the board lock body and the contact portion; and
a shielding member disposed outside the inner housing body, the shielding member comprising a shielding body, and an elastic arm extending from the shielding body into the space of the board lock body to engage the contact portion of the board lock.

11. The electrical connector of claim 10, wherein:
the outer housing body comprises an end portion shaped to accommodate the board lock, the end portion comprising a slot;
the board lock body is disposed in the slot of the end portion of the outer housing body; and
the inner housing body comprises a protrusion configured for retaining the elastic arm of the shielding member, the protrusion extending outwardly into the end portion of the outer housing body such that the elastic arm extends into the space of the board lock body.

12. The electrical connector of claim 11, wherein:
the protrusion comprises a first groove;
the inner housing body comprises a side wall comprising a second groove connected to the first groove; and
the elastic arm of the shielding member extends from the second groove into the first groove.

13. The electrical connector of claim 12, wherein:
the protrusion is a first protrusion; and
the side wall of the inner housing body comprises second protrusions configured for retaining the shielding body of the shielding member.

14. The electrical connector of claim 12, wherein:
the protrusion is sized such the inner housing body is movable relative to the outer housing body in a plane perpendicular to a mating direction; and
the plurality of conductive elements are configured to expand and contract in the mating direction, and to move transversely relative to the mating direction along with the inner housing body.

15. The electrical connector of claim 14, wherein:
the plurality of conductive elements comprise a plurality of signal terminals and a plurality of power terminals disposed on opposite sides of the plurality of signal terminals;
the intermediate portion of each of the plurality of signal terminals comprises a plurality of bending portions; and
the intermediate portion of each of the plurality of power terminals comprises a plurality of segments and a plurality of gaps disposed between adjacent segments, each of the plurality of segments comprising a plurality of bending portions.

16. The electrical connector of claim 14, wherein:
the outer housing body comprises first and second end portions disposed on opposite sides of the inner housing body;
the board lock is a first board lock held by the first end portion of the outer housing body;
the electrical connector comprises a second board lock held by the second end portion of the outer housing body; and
the inner housing body comprises first protrusions extending into the first and second end portions of the outer housing body, respectively.

17. The electrical connector of claim 15, wherein:
the inner housing body comprises a chamber configured to receive a mating component, and a plurality of tongues disposed in the chamber;
the plurality of tongues comprise a first tongue, and second tongues disposed on opposite sides of the first tongue and spaced from the first tongue;
the mating ends of the plurality of signal terminals are disposed along opposite sides of the first tongue; and
the mating ends of the plurality of power terminals are disposed along opposite sides of a respective second tongue.

18. The electrical connector of claim 10, wherein:
the inner housing body comprises a chamber configured to receive a mating component; and
the shielding member comprises a plurality of mating arms curving into the chamber and configured to contact with the mating component.

19. A method of operating an electrical connector system comprising first and second connectors, the first connector comprising a first plurality of conductive elements fixedly disposed in a first housing holding and a first shielding member disposed outside an inner body of the first housing, the second connector comprising a second plurality of conductive elements movably disposed in a second housing and a second shielding member disposed outside an inner body of the second housing, the method comprising:
inserting the inner body of the first housing into a chamber of the inner body of the second housing; and
moving the inner body of the second housing and/or the second plurality of conductive elements until the first and second connectors are mated with each other.

20. The method of claim 19, wherein:
the second housing of the second connector comprises a plurality of tongues disposed in the chamber of the inner body of the second housing;
inserting the inner body of the first housing comprises inserting the plurality of tongues of the second housing of the second connector into the inner body of the first housing;
the second shielding member of the second connector comprises an elastic arm engaging a board lock of the second connector; and
moving the inner body of the second housing and/or the second plurality of conductive elements comprises moving the elastic arm relative to the board lock while maintaining contact between the elastic arm and the board lock.
